(19) United States
(12) Patent Application Publication
(10) Pub. No.: US 2014/0258136 A1
(43) Pub. Date: Sep. 11, 2014

(54) METHOD FOR IMPROVING SECURITY OF ONLINE TRANSACTIONS

(71) Applicant: Gregory Duane Ellis, Orem, UT (US)

(72) Inventor: Gregory Duane Ellis, Orem, UT (US)

(21) Appl. No.: 14/201,785

(22) Filed: Mar. 7, 2014

Related U.S. Application Data
(60) Provisional application No. 61/774,514, filed on Mar. 7, 2013.

(51) Int. Cl. G06Q 20/40; G06Q 20/38

(52) U.S. Cl. CPC G06Q 20/4014; G06Q 20/38215
USPC 705/76

(57) ABSTRACT

The present invention provides a system, including a method and apparatus, for verifying, with a very high degree of certainty, the identity of an individual who desires to execute an online transaction for the purchase of goods or services. System function embodies a number of interconnected basic features. The first involves enabling a personal computerized device to be identified via user input data. The second involves the creation of a central, third-party identification database containing authentication information and having an authentication protocol. The third involves the provision of an individualized electronic certificate, which ties the identification of an individual computer or device user to the third-party identification database. The fourth involves the incorporation of the individualized electronic certificate in a particular individual computer or computerized device, which enables the establishment of the authentication protocol between the computerized device and the third-party website.

### BACKGROUND OF THE INVENTION

1. Field of the Invention

The present invention is related, generally, to methods for eliminating online transactional fraud and, more particularly, to a method which uses a security certificate that is uploaded from an identity verification service to each computerized device operated by an end user. The certificate is validated, by acquaintances within a social network, not only to identify a user, but also to identity any computerized device on which the validated certificate is loaded. The method can be enhanced by address verification and geo-location of portable devices implemented through GPS tracking of the user.

2. History of the Prior Art

Though global economic growth during the past six years has been at a virtual standstill, global online transactional fraud is alive and well. Credit card fraud associated with online sales transacted over the Internet has reached massive proportions, and the merchants providing goods and services over the net are suffering significant losses through chargebacks from the financial institutions who serve the targeted credit card holders. Merchants who offer a product or service online have to take the risk of losing the cost of the product sold online, plus the added cost of chargeback fees, and they even face the possibility of having their merchant account terminated by the financial institutions serving them. While these costs can, to some extent, be passed onto the consumer, the development of this hostile environment hurts business as a whole. Transactional fraud hurts small business owners most severely. The Cybersource® Online Fraud Report reported that:
in 2001, on sales totaling $53.1 billion, $1.7 billion (3.2 percent) was lost to fraud;
in 2002, on sales totaling $72.4 billion, $2.1 billion (2.9 percent) was lost to fraud;
in 2003, on sales totaling $152.9 billion, $1.9 billion (1.7 percent) was lost to fraud;
in 2004, on sales totaling $155.6 billion, $2.6 billion (1.8 percent) was lost to fraud;
in 2005, on sales totaling $175 billion, $2.8 billion (1.6 percent) was lost to fraud;
in 2006, on sales totaling $221.4 billion, $3.1 billion (1.4 percent) was lost to fraud;
in 2007, on sales totaling $264.3 billion, $3.7 billion (1.4 percent) was lost to fraud;
in 2008, on sales totaling $285.7 billion, $4.0 billion (1.4 percent) was lost to fraud;
in 2009, on sales totaling $275 billion, $3.3 billion (1.2 percent) was lost to fraud;
in 2010, on sales totaling $300 billion, $2.7 billion (0.9 percent) was lost to fraud;
in 2011, on sales totaling $340 billion, $3.4 billion (1.0 percent) was lost to fraud;
in 2012, on sales totaling $389 billion, $3.5 billion (0.9 percent) was lost to fraud.

It is interesting to note that losses to fraud, as a percentage of total sales, after hitting a high of 3.2 percent in 2001, gradually declined, but appear to have leveled off at around 1.0 percent. This may be an indication that using current fraud-reducing technologies, losses may hover around 1.0 percent of total sales for some time.

Fraudulent orders that have all the trappings of legitimate orders (i.e., they pass the typical fraud checks implemented by the merchant) are known as “clean” fraud. Nearly half of all online merchants say that the fraudulent orders they saw in 2011 were “cleaner” than those of the previous year. The increase in clean fraud is the most significant factor that merchants noticed in 2011. The game being played between online retailers and credit card thieves is much like the game of sophisticated weapons development. For each countermeasure to a hostile threat, there is a counter-countermeasure. As retailers continue to implement new security procedures for countering credit card fraud, thieves are attempting to remain at least one step ahead of retailers with their own counter-security measures.

Nearly every online business will incur charges attributable to visitors to its website who engage in fraudulent activity. In fact, fraud has become virtually synonymous with online business. Online fraud is multi-faceted. Not all fraudulent transactions are made to obtain merchandise. There are basically three basic types of fraud faced by online merchants.

The first type of fraud, known as card testing, is a type of credit card fraud with which many merchants may not even be familiar. It can be very costly to a business even though that business may never ship any merchandise as a result thereof. Card testing is the systematic testing of potential credit card numbers for the purpose of finding at least one valid card number. Card testing involves the attempted processing of a large number transactions through a payment gateway—usually for small amounts, and usually in a sequential and consistent pattern. The tester is only looking for valid credit card numbers, and is not yet ready to make fraudulent purchases of tangible goods. Most businesses are charged for every attempted credit card transaction, whether it is approved or declined. If card testers are not restricted in their activity, they will likely test thousands, or even tens of thousands, of credit card numbers in a single day. At about $0.25 per transaction, costs can accumulate rapidly. Visa and MasterCard also monitor gateway addresses, and will close merchant accounts that are associated with large numbers of declined credit card transactions—even if the merchant was unaware of the card testing.

Card testing involves two different phases. The first phase is the detection of a valid credit card number. The second phase is the discovery of the expiration date which matches the previously-detected valid credit card number. By using what is known as the Luhn algorithm, a tester can produce a list of valid credit card numbers. The Luhn algorithm, also known as the “modulus 10” or “mod 10” algorithm, is a simple checksum formula used to validate a variety of identification numbers, such as credit card numbers, IMEI numbers, National Provider Identifier numbers in US and Canadian Social Insurance Numbers. It was created by IBM scientist Hans Peter Luhn and described in U.S. Pat. No. 2,950,048, filed on Jan. 6, 1954, and granted on Aug. 23, 1960. The algorithm is in the public domain and is in wide use today. Most credit cards and many government identification numbers use the algorithm as a simple method of distinguishing valid numbers from collections of random digits. Once the credit card tester has compiled a list of potentially-valid credit card numbers, his next task is to determine which of those numbers are used on existing credit cards. This is where card number testing begins. Once the tester finds a real card number, he submits expiration dates until the card number is approved. The tester builds a computer script, which executes automated queries into a merchant's payment gateway. These scripts can be very complex and some can even foil fraud detection software.

Card testing is easily prevented. In order for card testing to be effective, two particular features must be present on an online payment gateway. Removal of either feature will nullify the effectiveness of card testing. The first feature is that the merchant's website must provide the reason for declining a credit card. The tester needs to know whether the card number was an invalid number or whether the expiration date was incorrect. The second factor required for effective card testing is that the credit card approval process not require a valid card holder address.

The second type of credit card fraud is the submission of fraudulent orders using stolen credit card information. A fraudulent order occurs when a stolen credit card is used to order merchandise that is subsequently shipped. The thief may have drop off addresses where he can pick up a delivery anonymously.

The third type of fraud is known as “friendly fraud.” Friendly fraud occurs when a merchant receives a claim because the cardholder denies making the purchase or receiving the order, yet the goods or services were actually received. In some instances, the order may have been placed by a family member or friend having access to the buyer's credit card information.

Businesses certainly suffer the consequences of fraud more than do consumers. Credit card fraud regulations are designed to protect the consumer rather than businesses. A business has very little, if any, recourse if it processes a fraudulent order and, then, ships merchandise. On the other hand, businesses are better equipped to fight fraud than are consumers, as businesses are in a powerful position that enables them to void any transaction which smacks of fraud. Businesses should always remember that is far easier to void a suspicious transaction than to recover merchandise that has been shipped to a thief. Lost merchandise and credit card chargebacks will plague careless or unwary merchants.

Though fraudulent orders are more difficult to stop than card testing, most fraudulent orders processed at the payment gateway of an online website can be identified and terminated, via careful order analysis, before the shipment of merchandise has occurred.

Fraudulent orders typically have multiple unique characteristics that distinguish them from normal, legitimate orders. Those unique characteristics include: a request for expedited shipping; an unusual shipping address; an offer to purchase an item at more than the listed price; an abnormally high invoice amount; an unusually high quantity of product; an unusual type of product; non-matching shipping and billing addresses; order placement originates in a foreign country where fraud is widespread, such as the Ukraine, Indonesia, Yugoslavia, Lithuania, Egypt, Romania, Bulgaria, Turkey, Russia, Pakistan, Malaysia, Israel, Nigeria (as well as any other country in Africa), Indonesia, or the Philippines; the purchaser has listed an incorrect or invalid telephone number; the purchaser previously requested a list of products; the purchaser has a fake sounding name; and the purchaser has an email address provided by a service such as mail.com, hotmail.com, gmail.com, or yahoo.com.

Online merchants should always require purchasers to input the three or four-digit CVV/CV2/CVC (Card Verification Code) for every transaction. This almost certainly guarantees that the purchaser has the actual card in his hand, and that billing is being made to an address registered to the card. It is also imperative that online merchants implement an Address Verification System. The Address Verification system (AVS) is a system used to verify numeric portions of the address of a person claiming to own a credit card. The system checks the billing address of the credit card provided by the user with the address on file at the credit card company. If the two do not match, there is a high probability that the transaction is fraudulent.

Whenever an online merchant comes across a suspicious order, a telephone call should be made to the customer so that his identity can be verified. If the order is large, or talking to them is unconvincing, it is best to request that customer fax to the merchant a copy of his driver's license, together with a signed copy of the invoice. If possible, a signature should be required for every package that is delivered, as a signature is the only proof of delivery.

Every online merchant should be familiar with the hallmarks of credit card fraud, understand that, though it can never be completely eliminated, it can be effectively managed and reduced to a tolerable level.

What is needed is a more effective way of establishing the true identity of online customers so as to more effectively reduce the incidence of credit card fraud.

### SUMMARY OF THE INVENTION

The present invention provides a system, including a method and apparatus, for verifying, with a very high degree of certainty, the identity of an individual who desires to execute an online transaction for the purchase of goods or services. System function embodies a number of interrelated system components. The first component is an online database for storing detailed identity information for a plurality of individual users who desire to participate, as buyers, in online commerce. The database is hosted by a third party managing company. The second component is an online application that enables individual users to create an identity record, which will be stored in the online database. The third component is an identity authentication procedure that enables the managing company to authenticate the validity of individual identity records that have been created. Validation of individual identity records can be accomplished by a number of routine security checks and by sending an email to a number of randomly selected social media network friends of the user, along with a photograph of the user identified by name and certain user-specific information that further identifies that user. Each friend is asked to state in a return email message whether he or she personally knows the individual user and whether the photo and personal information provided in the received email pertain to the user. The fourth component is a software module that enables the managing company to create an electronic identity certificate for each of its users whose identity has been validated. A fifth component is a download and scanning software module that enables the user to download a copy of his electronic identity certificate and install it on the root directory of each computer or device which he intends to use to transact online purchases. The module enables the managing company to scan the device for device-centric parameters, such as a Media Access Control address (MAC address) that is unique to that device, the motherboard serial number, and other information provided by the operating system of the computer or device. The download and scanning module enables the establishment of an authentication protocol between the computer or computerized device and the identity authentication database.

A online retailer of goods and services that has a subscription to the identity authentication service provided by the identity authentication website, can contact the identity authentication website and initiate an API query that will determine whether or not the identity of the owner of a contacting computer or computerized device has been certified by the identity authentication website.

An optional sixth component of the system an additional identity verification technique, which will be called a “Location Probability Footprint” (LPF).

The authentication website uses the location-based Internet protocol GPS on a computerized device, such as cell phone, to create a user movement tracking history. This tracking history is used as an additional identity verification tool. For example, most people (even those who travel) spend 90% of their physical time in the same locations. Thus, most users will usually be present at a home GPS location, an office GPS location, or somewhere in between while traveling back and forth between the home and office locations. Most humans are creatures of habit. For example, when a traveler visits a foreign city on a regular basis, he typically frequents the same hotel area, as well as the same restaurants. Thus, the authentication website keeps track of the end user's movement and, thereby, determines that user's physical location habits. Using this stored information, the identity authentication website can give a verified user a Location Probability Footprint for his home city, as well as for national and international travel.

### BRIEF DESCRIPTION OF THE DRAWINGS

FIG. 1 is a flow chart showing use of the identity authentication service website; and

FIG. 2 is a flow chart showing profile completion by a registered user.

### DETAILED DESCRIPTION OF THE INVENTION

The invention will now be described in detail with reference to the attached drawing figures. The present invention provides a system, including a method and apparatus, for verifying, with a very high degree of certainty, the identity of an individual who desires to execute an online transaction for the purchase of goods or services.

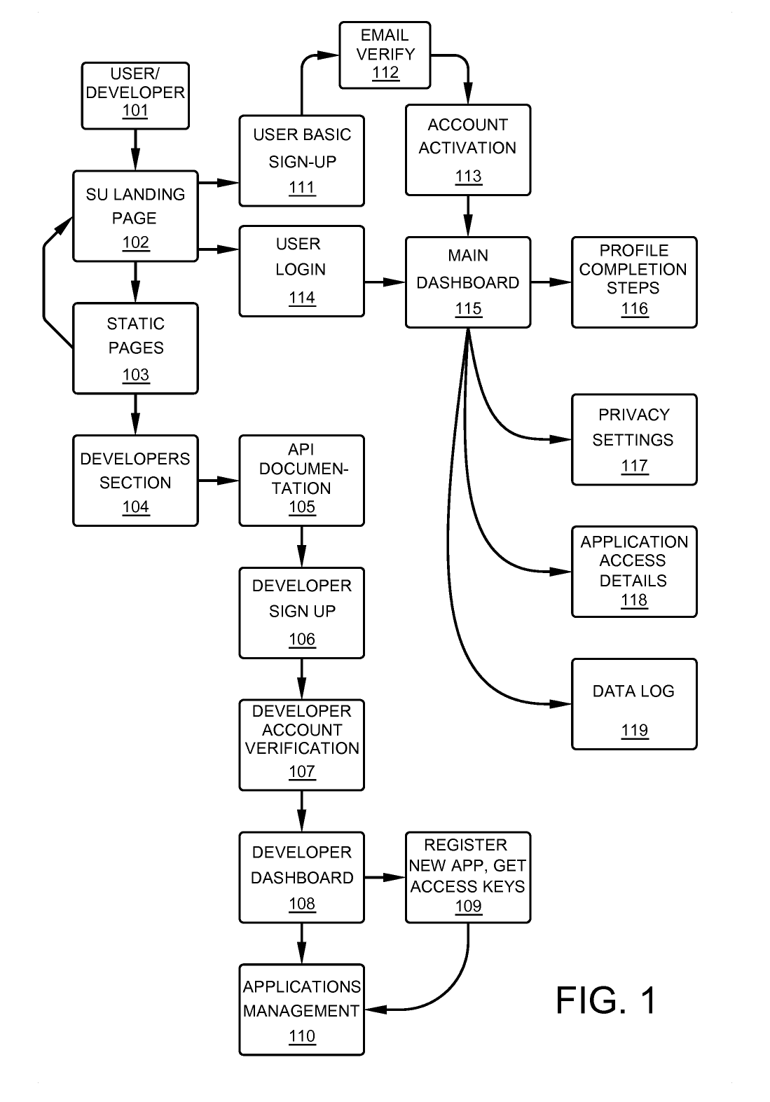

Referring now to FIG. 1, a credit card holder (hereinafter, also “user”) or software developer 101 contacts the secure user (SU) website and enters the landing page 102. The user or developer 101 can visit static pages 103 and either return to the landing page 102 or enter the developers section 104. A prospective developer may desire to peruse application programming interface (API) documentation for the purpose of developing a handshake between another website and the identity authentication service. The developer may sign up or sign in with the identity authentication service at 106, have his account verified 107, go to the developer dashboard 108, from which the developer can register a new handshake application for another website and get access keys 109. He may also go to the applications management page 110 where his API can be updated. Although the invention is primarily concerned with authenticating the identity of credit card holders (users), other businesses may also be interested in the process of identity verification even is not directly connected to the use of a credit card. Thus, developers can access the website, receive application programming interface (API) documentation, register new applications, and receive access keys for the new applications.

Still referring to FIG. 1, a credit card holder, or user, moves from the landing page 102 to the user basic sign-up page 111. The user provides his full name, an email address and selects a password, after which the user's email address is verified by sending a message with a verification link to the user's email account, the user's account is activated 113. After activation, the user taken to the main dashboard page 115. On subsequent visits to the secure user website, the user can simply log in to his account at 114, without first going through user basic sign-up 111. The main dashboard page 115 enables the user 101 to complete a personal profile.

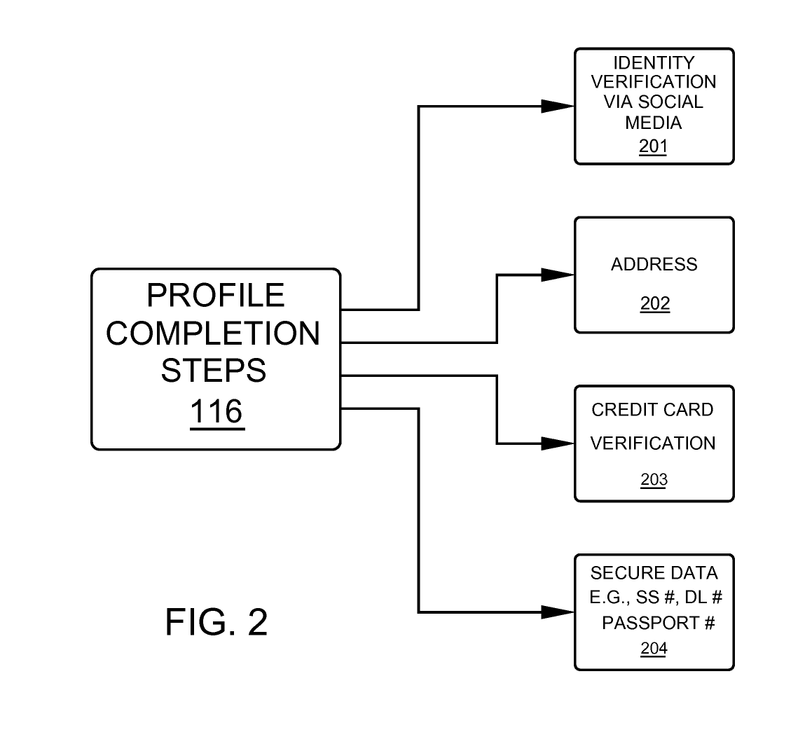

Referring to FIG. 2, profile completion requires the user to provide personal social media page information 201 for common social media networks such as Facebook® and LinkedIn®. The user's full residence address 202 is also required, as is his credit card information 203, the accuracy and validity of which is verified by the identity authentication service. Secure data, such as social security number, driver's license information (number and state), as well as passport number if the user has a passport. Along with this secure data, a recent photograph of the user is also submitted to the identity authentication service.

Referring once again to FIG. 1, from the main dashboard page 115, the user can adjust privacy settings 117, view application access details 118 and view a data log of all past online transactions in which the identity authentication service was involved.

The identity authentication service enables a credit card holder to, first, identify himself through user input entered on a given computer device, such as a personal computer, tablet computer, or mobile phone, and provided to the identity authentication service. The identifying information can include the user's full legal name in the country of residence, the user's physical address, the user's telephone number(s), the user's date of birth, the user's government-issued identification number(s), a photo of the government-issued identification card, such as a driver's license or passport photo, and any other identifying data deemed relevant. In addition, the user also provides identifying data pertinent to a social network, such as Facebook® or LinkedIn®. Identifying data includes the username and identifying credentials. In order to assist in reliable verification of identity of the user, the system invokes a Facebook friend query or a LinkedIn associate querry to validate the user. The friends or associates are, preferably, randomly chosen from the list of friends and associates.

The invention further involves the creation of a central, cloud-based certificate repository identification database having an authentication protocol that enables a third party operator of the database to verify the identity of a user from the unique identifier data input by the user. The database receives each input value provided by a user from a portal website and stores those inputs in a file for each user, which contains the user-provided reference information, in an identity authentication database. The user-provided data stored on the identity authentication database is cross-checked with automated referenced points, as well as by human verification via cross checking protocols invoked by third-party providers.

For example, when a government identification number (i.e., a social security number) is provided by the user, this number is cross checked at http://www.ssnvalidator.com/ to verify that the number provided is a valid social security number. When a Facebook profile name and credentials are entered, a protocol is invoked that sends an alert to three random Facebook friends of the individual using the identity authentication service. These Facebook friends are then shown the profile photo of the user who is making the verification request, and these friends are asked, “Is this person Mr. John Doe?” (With the user's real name, of course, provided in place of John Doe). These three individuals then may answer with one click, yes or no, and that information is passed along to the certificate repository database. If all three friends answer yes, then the data base continues the verification process.

The invention also involves a method for generating an individualized electronic certificate, which ties the identification of a user of one or more particular electronic computing devices to the database containing that user's authentication information.

When a user record is completed in accordance with the form submission criteria outlined in the first facet of the invention, that record is then linked to an issued electronic certificate. The electronic certificate is a secure certificate that has a specific numeric identifier. The certificate can be downloaded onto any electronic device having a web browser that is operated by the user via a one-step process initiated at a web page interface of the identity authentication service.

Using the same download process, the certificate can be downloaded to any number of devices operated by the end user and which he intends to use for accessing online merchants. The certificate can be downloaded to a given computerized device through a one-step process via a web page interface at the secure identity authentication service website. The one-step process is initiated by the user accessing the authentication website via an Internet browser. The device is then queried by the identity authentication website, and during a brief scan of the device (whether it be a personal computer, tablet or cell phone) device-centric properties are discerned and loaded in the end user's database record already stored by the identity authentication website. Device-centric properties may include the unique media access control address (MAC address) of a network interface that is incorporated into the computer; the motherboard serial number, and hard drive type. The end user certificate is uploaded by the identity authentication website to the root directory of the accessing computerized device.

The end user certificate grants permission, for the device on which it is loaded, to communicate with the identity authentication website and to answer an API query initiated by an online merchant website. An online merchant having a subscription to the identity authentication service provided by the identity authentication website, can contact the identity authentication website and initiate the API query that will determine whether or not the contacting device is certified by the identity authentication website.

An optional feature of the invention is an identity verification technique, which will be called a “Location Probability Footprint” (LPF).

The authentication website uses the location-based Internet protocol GPS on a computerized device, such as cell phone, to create a user movement tracking history. This tracking history is used as an additional identity verification tool. For example, most people (even those who travel) spend 90% of their physical time in the same locations. Home GPS location, Office GPS location, travel back and forth between the two. Most humans are creatures of habit. For example, when a traveler visits a foreign city on a regular basis, he typically frequents the same hotel area, as well as the same restaurants. Thus, the authentication website keeps track of the end user's movement and, thereby, determines that user's physical location habits. Using this stored information, the identity authentication website can give a verified user a Location Probability Footprint.

This information enables an online merchant to query the identity authentication website, which verifies that the end user's location is a normal one. If the user is accessing the web with his home-based personal computer, the identity authentication service will be able to identify the computer and will be able to inform a third-party vendor that the order is being made from the user's home-based personal computer. The same is true of a cell phone. In fact, the GPS module on the cell phone can give a real time location fix. That fix can also be compared to the Location Probability Footprint and assure a third-party vendor that there is a very high probability that the buyer's identity has been verified not only by correlating the user's current fix with his Location Probability Footprint, but also by verifying that the device through which the order is being placed does in fact belong to the user.

Thus, by meshing pre-recorded static verified data with a real-time GPS fix, an end user's identity can be verified with much greater certainty.

Consequently, a scam mer living in Nigeria, who has stolen a user's credit card information, and attempts to buy something on eBay, will not have the same Location Probability Footprint (LPF) as the actual end user when he is queried by the identity authentication service.

This feature has additional uses. With an LPF protocol, an end user having a authenticated identity can be protected in transactions that are real world, in the following way: If that users' credit card is tendered in a store such as Wallmart, the identity authentication SSU can query the user's cell phone to see if the user is in the same location as his credit card, in real time.

If the card is in a different geo-fenced location, (i.e., more than 3 miles from the user's cell phone being queried) and this distance could be set by the user ahead of time, then the card issuer would say, the user's card is being used in Georgia, 1,000 miles away, but the user's cell phone, and PC, were used in Utah 30 minutes prior to the transaction. Thus, the transaction is suspect, and halted until such time as the transaction can be verified as legitimate.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention as hereinafter claimed.

What is claimed is:

1. A method for verifying user identity and preventing credit card fraud in the context of online transactions, said method comprising the steps of:
establishing a security service having a centralized, cloud-based identification document and identification verification certificate repository database;
creating an identification document for each participating credit card holder which is loaded into the database as an accessible record, said identification document being created via personal inputs submitted by a credit card holder, said personal inputs including the holder's full legal name, residential address, telephone numbers, birth date, government-issued identification numbers, and at least one photo on a government-issued identification card;
cross-checking identification information provided by each participating credit card holder against other online databases in order to validate or invalidate the identity of each participating credit card holder;
issuing an electronic identity certificate for those participating credit card holders having a validated identification document;
enabling a credit card holder to download the electronic identity certificate from the database and install it in a root directory of a device being used by the credit card holder to access the database;
enabling an online merchant to access the security service via an application programming interface, which then connects a prospective online purchaser directly to the security service, so that the security service can determine whether or not the connecting device of the prospective purchaser has a valid electronic identity certificate that is consistent with that prospective purchaser's credit card number and name, and notify the merchant of the presence or absence of a consistent electronic identity certificate;
thereby enabling the online merchant to approve the online transaction if the credit card information tendered is associated with a valid electronic identity certificate or reject the online transaction as potentially fraudulent if the credit card information tendered is not associated with a valid electronic identity certificate.

2. The method for verifying user identity of claim 1, which further comprises the steps of:
enabling a participating credit card holder to download his electronic identity certificate to each computerized device which he uses for purchases from online merchants.

3. The method of verifying user identity of claim 1, which further comprises the step of validating a participating credit card holder's identity by contacting acquaintances of the card holder within a social media network and querying them as to the card holder's identity.

4. The method of verifying user identity of claim 1, which further comprises the step of having the security service scan each computerized device on which an electronic identity certificate is loaded so that unique identifying information about the device can be included in the participating credit card holder's identification document so that the security service can recognize not only the presence of an electronic identity certificate, but unique characteristics of each computerized device on which it is loaded.

5. The method for verifying user identity of claim 1, which further comprises the steps of:
establishing a location probability footprint for each credit card holder via static verified location data combined with GPS tracking of mobile devices;
determining whether a prospective purchaser at an online purchase portal is an authorized credit card holder or a pretender based on his current location deviation from an established location probability footprint.

6. The method for verifying user identity of claim 5, wherein a credit card holder's location probability footprint is determined as a function of GPS location data accumulated over a period of time at regular intervals, said location data being uploaded to the security service and stored as a data file in the document and certificate repository identification database.

7. The method of verifying user identity of claim 5, which further comprises the steps of:
having an online merchant contact the security service when a prospective purchaser at an online purchase portal attempts to purchase goods or services using credit card information, said security service querying a cell phone registered with the security service that corresponds to a credit card holder having a credit card with the credit card information tendered by the prospective purchaser;
obtaining a real-time GPS fix for the credit card holder's cell phone;
comparing the real-time GPS fix with the prospective purchaser's current location, as determined by static verified location data;
determining whether the prospective purchaser is the authorized credit card holder or a pretender based on a calculation of a distance between the queried cell phone and the static verified location data.
